(19) United States
(12) Patent Application Publication
(10) Pub. No.: US 2026/0154377 A1
(43) Pub. Date: Jun. 4, 2026

(54) SYSTEM AND METHOD FOR GENERATING RECOURSE DATA WITH PATH SIMILARITY PROPAGATION AND COUNTERFACTUALS

(71) Applicant: JPMorgan Chase Bank, N.A., New York, NY (US)

(72) Inventors: Abdullah ALSHELAHI, Exton, PA (US); Eugeniu SPINU, Westerville, OH (US); Margarita BOYARSKAYA, New York, NY (US); Sivapriya VELLAICHAMY, Jersey City, NJ (US); Alima NURLAN, Wilmington, DE (US); Shubham SHARMA, Manhattan, NY (US); Freddy LECUE, Mamaroneck, NY (US); Bivor MALLIK, West Chester, PA (US); FengQin ZHAO, West Chester, PA (US)

(73) Assignee: JPMorgan Chase Bank, N.A., New York, NY (US)

(21) Appl. No.: 18/966,815

(22) Filed: Dec. 3, 2024

(51) Int. Cl. G06Q 40/02; G06F 18/2321

(52) U.S. Cl. CPC G06F 18/2321

(57) ABSTRACT

Various methods and processes, apparatuses/systems, and media for generating recourse data for a denied applicant are disclosed. A processor trains a machine learning model by using a first set of training data and a second set of training data which outputs risk classification data associated with a negative decision; identifies, based on the risk classification data, the denied applicant who received the negative decision; identifies individuals whose applications were initially rejected but approved later based on accessing historical data from a database; groups the individuals, whose applications were initially rejected but approved later, into a high density cluster by applying a clustering algorithm; and generates, by applying a computing algorithm, a recourse data for the denied applicant utilizing similar individuals within the high density cluster whose applications were initially rejected but approved later and whose features values at initial rejection are similar to features values of the denied applicant.

### TECHNICAL FIELD

This disclosure generally relates to data processing, and, more particularly, to methods and apparatuses for implementing a platform, language, cloud, and database agnostic recourse data generating module configured to generate actionable changes (recourse) with path similarity propagation and counterfactuals.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

When individuals receive adverse outcomes (e.g., rejected applicants) in response to seeking loans, credit cards, or other services from systems, providing a recourse path to help achieve a positive outcome may be desirable. Recent work has shown that counterfactual explanations—which might be used as a means of single-step recourse—may be vulnerable to privacy issues, putting an individuals' privacy at risk. Providing a sequential multi-step path for recourse may amplify this risk. Furthermore, simply adding noise to recourse paths found from existing methods may impact the realism and actionability of the path for an end-user.

For example, numerous systems, such as credit approval processes, are often driven by machine learning models to provide decisions. When individuals are adversely affected by these decisions, it may become crucial to offer transparent explanations. Although these explanations may currently help the denied individuals understand why they received a negative outcome, but not how to improve their chances for a positive outcome in the future. Recommending actionable changes to specific features may prove to be complicated due to a lack of understanding regarding which features among many could potentially be altered to increase model score and thereby enhance the likelihood of application approval. The availability of data on previously denied applicants who were able to get approved shortly after may be important to generate actionable changes that may help a currently denied applicant's chances for a positive outcome in the future.

Currently, conventional techniques fail to analyze available time series data that observes the evolution of features over time for learning of feasibility empirically, thereby failing to identify data on previously denied applicants who were able to get approved shortly thereafter. Thus, these conventional techniques lack configurations for identifying actionable changes that customers with declined applications may undertake to enhance the likelihood of their new application being approved after implementing the recommended changes.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic recourse data generating module configured to implement artificial intelligence and machine learning models and techniques to generate actionable changes that customers with declined applications may undertake to enhance the likelihood of their new application being approved after implementing the recommended changes, but the disclosure is not limited thereto.

In some embodiments, a method for generating recourse data with path similarity propagation and counterfactuals for a negatively classified individual by utilizing one or more processors along with allocated memory is disclosed. The method may include: receiving a first set of training data and a second set of training data that are usable for training a machine learning model, each training data including a plurality of feature values associated with a positive decision or a negative decision on applications received from individuals seeking a pre-desired service from an institution; training the machine learning model by using the first set of training data and the second set of training data to output risk classification data associated with the negative decision; identifying, based on the risk classification data, a negatively classified individual who received the negative decision; identifying, for the negatively classified individual, individuals whose applications were previously rejected but approved after a certain period of time based on accessing historical data from a database; grouping, for the negatively classified individual, the individuals whose applications were previously rejected but approved after the certain period of time into a high density cluster by applying a clustering algorithm; and generating, by applying a computing algorithm, a recourse data for the negatively classified individual utilizing similar individuals within the high density cluster whose applications were previously rejected but approved after the certain period of time, and whose features values at a time of rejection are similar to features values of the negatively classified individual thereby increasing performance of the machine learning model and allowing the negatively classified individual to change the negative decision to the positive decision by implementing the recourse data.

In some embodiments, the features values represent one or more of the following data: credit score data, account balance data, data representing how may accounts, mortgage loan data, income data, and car loan data, but the disclosure is not limited thereto. For example, although the processes as disclosed herein utilized loan or credit card application, the processes as disclosed herein may be utilized in other use cases, such as where one may change rejected status to an approved status, e.g., managing, matching, and sourcing employment candidates in a recruitment campaign, making decision on carrier improvement, making decision on administering doses of medicine for a treatment plan for a patient, making decision on admitting a patient, admission process to an educational institution where one may change rejected status to an approved status, etc., but the disclosure is not limited thereto.

In some embodiments, in applying the clustering algorithm, the method may further include: determining a parameter “epsilon” which is a radius of a circle that is drawn around a data point representing the negatively classified individual to determine how many other data points representing the individuals whose applications were previously rejected but approved after the certain period of time are within the circle; and adjusting the epsilon until a preconfigured number of data points representing the individuals whose applications were previously rejected but approved after the certain period of time have a nearby approved individual.

In some embodiments, the positive decision may represent an approved state on applications received from the individuals seeking the pre-desired service from the institution and the negative decision may represent a declined state on applications received from the individuals seeking the pre-desired service from the institution.

In some embodiments, in generating the recourse data by applying the computing algorithm, the method may further include: determining a data point representing the nearby approved individual whose application was previously rejected but approved after the certain period of time to the data point representing the negatively classified individual within the high density cluster considering the declined state; computing a difference in distance between the data point representing the negatively classified individual and a data point of the nearby approved individual within the high density cluster; and generating the recourse data for the negatively classified individual based on the computed difference.

In some embodiments, the method may further include: outputting the recourse data to a graphical user interface of a computing device utilized by the negatively classified individual.

In some embodiments, the machine learning model may include one or more of the following models: decision tree, ensemble trees, logistic regression, neural network architectures, and predictive model.

In some embodiments, a system for generating recourse data with path similarity propagation and counterfactuals for a negatively classified individual is disclosed. The system may include: a processor; and a memory operatively connected to the processor via a communication interface, the memory storing computer readable instructions, when executed, may cause the processor to: receive a first set of training data and a second set of training data that are usable for training a machine learning model, each training data including a plurality of feature values associated with a positive decision or a negative decision on applications received from individuals seeking a pre-desired service from an institution; train the machine learning model by using the first set of training data and the second set of training data to output risk classification data associated with the negative decision; identify, based on the risk classification data, a negatively classified individual who received the negative decision; identify, for the negatively classified individual, individuals whose applications were previously rejected but approved after a certain period of time based on accessing historical data from a database; group, for the negatively classified individual, the individuals whose applications were previously rejected but approved after the certain period of time into a high density cluster by applying a clustering algorithm; and generate, by applying a computing algorithm, a recourse data for the negatively classified individual utilizing similar individuals within the high density cluster whose applications were previously rejected but approved after the certain period of time, and whose features values at a time of rejection are similar to features values of the negatively classified individual, thereby increasing performance of the machine learning model and allowing the negatively classified individual to change the negative decision to the positive decision by implementing the recourse data, wherein the features values may represent one or more of the following data: credit score data, account balance data, data representing how may accounts, mortgage loan data, income data, and car loan data, but the disclosure is not limited thereto. For example, the features values may represent other data as disclosed above.

In some embodiments, the processor may be further configured to: output the recourse data to a graphical user interface of a computing device utilized by the negatively classified individual.

In some embodiments, in applying the clustering algorithm, the processor may be further configured to: determine a parameter “epsilon” which is a radius of a circle that is drawn around a data point representing the negatively classified individual to determine how many other data points representing the individuals whose applications were previously rejected but approved after the certain period of time are within the circle; and adjusting the epsilon until a preconfigured number of data points representing the individuals whose applications were previously rejected but approved after the certain period of time have a nearby approved individual.

In some embodiments, the positive decision may represent an approved state on applications received from the individuals seeking the pre-desired service from the institution and the negative decision may represent a declined state on applications received from the individuals seeking the pre-desired service from the institution, and in generating the recourse data by applying the computing algorithm, the processor may be further configured to: determine a data point representing the nearby approved individual whose application was previously rejected but approved after the certain period of time to the data point representing the negatively classified individual within the high density cluster considering the declined state; compute a difference in distance between the data point representing the negatively classified individual and a data point of the nearby approved individual within the high density cluster; and generate the recourse data for the negatively classified individual based on the computed difference.

In some embodiments, a non-transitory computer readable medium configured to store instructions for generating recourse data with path similarity propagation and counterfactuals for a negatively classified individual is disclosed. The instructions, when executed, may cause a processor to perform the following: receiving a first set of training data and a second set of training data that are usable for training a machine learning model, each training data including a plurality of feature values associated with a positive decision or a negative decision on applications received from individuals seeking a pre-desired service from an institution; training the machine learning model by using the first set of training data and the second set of training data to output risk classification data associated with the negative decision; identifying, based on the risk classification data, a negatively classified individual who received the negative decision; identifying, for the negatively classified individual, individuals whose applications were previously rejected but approved after a certain period of time based on accessing historical data from a database; grouping, for the negatively classified individual, the individuals whose applications were previously rejected but approved after the certain period of time into a high density cluster by applying a clustering algorithm; and generating, by applying a computing algorithm, a recourse data for the negatively classified individual utilizing similar individuals within the high density cluster whose applications were previously rejected but approved after the certain period of time, and whose features values at a time of rejection are similar to features values of the negatively classified individual thereby increasing performance of the machine learning model and allowing the negatively classified individual to change the negative decision to the positive decision by implementing the recourse data, wherein the features values may represent one or more of the following data: credit score data, account balance data, data representing how may accounts, mortgage loan data, income data, and car loan data, but the disclosure is not limited thereto. For example, the features values may represent other data as disclosed above.

In some embodiments, the instructions, when executed, may cause the processor to further perform the following: outputting the recourse data to a graphical user interface of a computing device utilized by the negatively classified individual.

In some embodiments, in applying the clustering algorithm, the instructions, when executed, may cause the processor to further perform the following: determining a parameter “epsilon” which is a radius of a circle that is drawn around a data point representing the negatively classified individual to determine how many other data points representing the individuals whose applications were previously rejected but approved after the certain period of time are within the circle; and adjusting the epsilon until a preconfigured number of data points representing the individuals whose applications were previously rejected but approved after the certain period of time have a nearby approved individual.

In some embodiments, the positive decision may represent an approved state on applications received from the individuals seeking the pre-desired service from the institution and the negative decision may represent a declined state on applications received from the individuals seeking the pre-desired service from the institution, and in generating the recourse data by applying the computing algorithm, the instructions, when executed, may cause the processor to further perform the following: determining a data point representing the nearby approved individual whose application was previously rejected but approved after the certain period of time to the data point representing the negatively classified individual within the high density cluster considering the declined state; computing a difference in distance between the data point representing the negatively classified individual and a data point of the nearby approved individual within the high density cluster; and generating the recourse data for the negatively classified individual based on the computed difference.

In some embodiments, the instructions, when executed, may cause the processor to further perform the following: outputting the recourse data to a graphical user interface of a computing device utilized by the negatively classified individual.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic recourse data generating module configured to generate actionable changes with path similarity propagation and counterfactuals in accordance with an embodiment.

FIG. 2 illustrates a diagram of a network environment with a platform, language, database, and cloud agnostic recourse data generating device in accordance with an embodiment.

FIG. 3 illustrates a system diagram for implementing a platform, language, database, and cloud agnostic recourse data generating device having a platform, language, database, and cloud agnostic recourse data generating module in accordance with an embodiment.

FIG. 4 illustrates a system diagram for implementing a platform, language, database, and cloud agnostic recourse data generating module of FIG. 3 in accordance with an embodiment.

FIG. 5 illustrates a graphical representation of declined and approved states of applicants and identification of applicants who are neighbors to a currently declined applicant in accordance with an embodiment.

FIG. 6 illustrates a graphical representation of clusters of applicants who successfully changed their status from a declined state to an approved state in accordance with an embodiment.

FIG. 7 illustrates a process implemented by the platform, language, database, and cloud agnostic recourse data generating module of FIG. 4 for computing actionable changes utilizing successful applications of similar applicants/individuals in accordance with an embodiment.

FIG. 8 illustrates a flow chart of a process implemented by the platform, language, database, and cloud agnostic recourse data generating module of FIG. 4 for generating actionable changes with path similarity propagation and counterfactuals in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Numerous systems, such as credit approval processes, are often driven by machine learning models to provide decisions. When individuals are adversely affected by these decisions, it may become crucial to offer transparent explanations. Although these explanations may currently help the denied individuals understand why they received a negative outcome, but not how to improve their chances for a positive outcome in the future. Recommending actionable changes to specific features may prove to be complicated due to a lack of understanding regarding which features among many could potentially be altered to increase model score and thereby enhance the likelihood of application approval. The availability of data on previously denied applicants who were able to get approved shortly after may be important to generate actionable changes that may help a currently denied applicant's chances for a positive outcome in the future.

That is because, conventional systems/techniques fail to analyze available time series data that observes the evolution of features over time for learning of feasibility empirically corresponding to the loan or credit card application approval processes due to lack of knowledge of which features are possible or likely to change as well as lack of knowledge of availability of data on previously denied applicants who were able to get approved shortly thereafter. Typically, a time series data may correspond to a series of data points indexed in time order. A wide variety of data may be represented as a time series, such as daily temperatures, closing values of markets, decisions on applications for loans or credit cards, as well as data relating to network performance such as latency, packet loss or network outages. These conventional techniques may lack configuration for implementing artificial intelligence techniques for generating actionable features from the time series data associated with a negative outcome in connection with loan or credit approval (e.g., features that may feasibly be improved over time) where actionability is not known because these conventional techniques assume it to be given a priory (e.g., as a list of features that are hard coded as possible/impossible to change). Moreover, these conventional techniques may lack configuration for implementing artificial intelligence techniques for identifying actionable changes/features that customers with declined applications may undertake to enhance the likelihood of their new application being approved after implementing the recommended changes.

In addition, latencies between large groups of endpoints pairs in connection with time series data associated with loan or credit card application approval processes may increase simultaneously due to the degradation of shared portions of their path(s). Evaluating streams of network data in connection with these time series data in real-time to identify network failure events would greatly benefit network efficiency and operation, however doing so may prove to be difficult because the network data often includes noise, missing values, and/or inconsistent time granularity in its recourse paths. Furthermore, simply adding noise to recourse paths found from existing methods may impact the realism and actionability of the path for an end-user. In addition, real-time monitoring and evaluation involves processing extremely large amounts of network data associated with time series data may also prove to be difficult to scale as the size and complexity of modern network infrastructures grow.

The present disclosure, through one or more of its various aspects, embodiments, and/or specific features or sub-components, provides, among other features, various systems, servers, devices, methods, media, programs, and platforms for implementing a platform, language, cloud, and database agnostic recourse data generating module configured to implement artificial intelligence and machine learning models and techniques to identify/generate actionable changes that customers with declined applications may undertake to enhance the likelihood of their new application being approved after implementing the recommended changes, by analyzing time series data associated with loan or credit card application approval processes and generating recourse with path similarity propagation and counterfactuals generated from availability data corresponding to previously denied applicants who were able to get approved shortly thereafter, thereby substantially reducing latencies between large groups of endpoints pairs in connection with time series data associated with loan or credit card application approval processes, and in turn improving underlying network performance, but the disclosure is not limited thereto.

Although the processes as disclosed herein utilized loan or credit card application, the processes as disclosed herein may be utilized in other use cases, such as where one may change rejected status to an approved status, e.g., managing, matching, and sourcing employment candidates in a recruitment campaign, making decision on carrier improvement, making decision on administering doses of medicine for a treatment plan for a patient, making decision on admitting a patient, admission process to an educational institution where one may change rejected status to an approved status, etc., but the disclosure is not limited thereto.

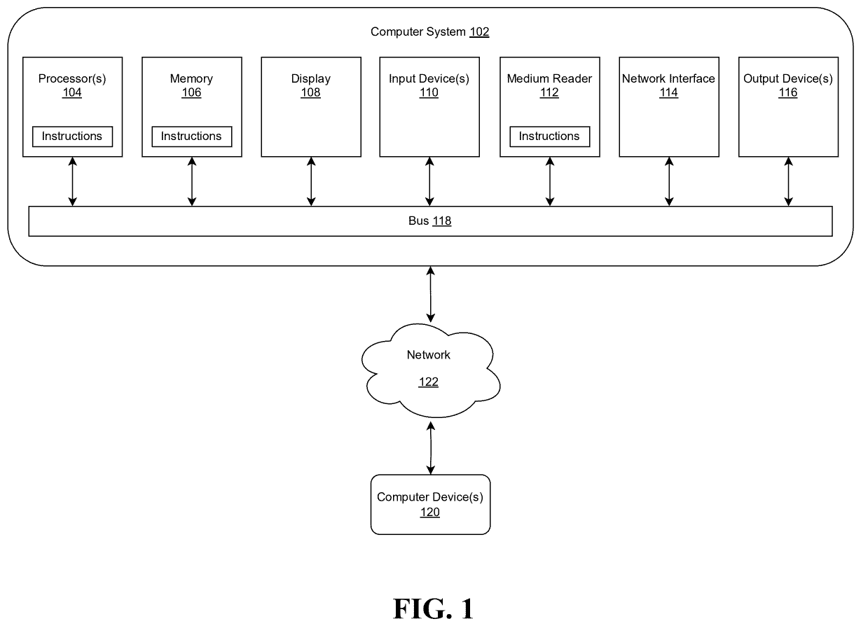

FIG. 1 is an exemplary system 100 for use in implementing a platform, language, database, and cloud agnostic recourse data generating module configured to implement artificial intelligence and machine learning models and techniques to identify/generate most important and actionable changes that customers with declined applications may undertake to enhance the likelihood of their new application being approved after implementing the recommended changes in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the recourse data generating module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the recourse data generating module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

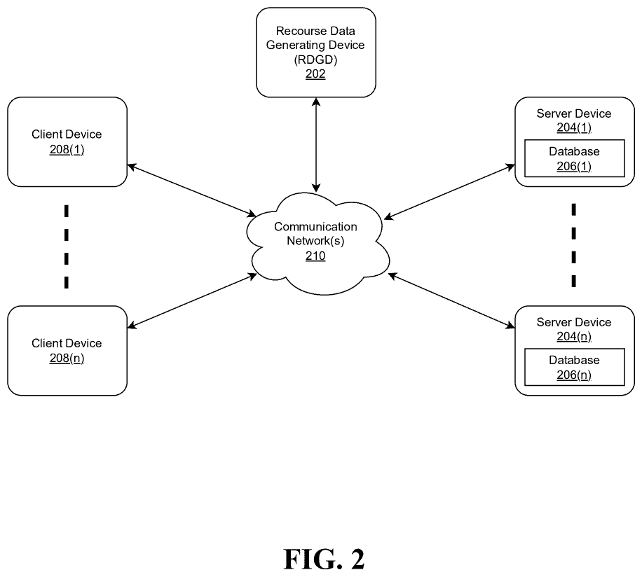

Referring to FIG. 2, a schematic of an exemplary network environment 200 for implementing a language, platform, database, and cloud agnostic recourse data generating device (RDGD) of the instant disclosure is illustrated.

In some embodiments, the above-described problems associated with conventional tools may be overcome by implementing an RDGD 202 as illustrated in FIG. 2 that may be configured for implementing a platform, language, database, and cloud agnostic recourse data generating module configured to implement artificial intelligence and machine learning models and techniques to generate actionable changes that customers with declined applications may undertake to enhance the likelihood of their new application being approved after implementing the recommended changes, but the disclosure is not limited thereto.

The RDGD 202 may have one or more computer system 102s, as described with respect to FIG. 1, which in aggregate provide the necessary functions.

The RDGD 202 may store one or more applications that may include executable instructions that, when executed by the RDGD 202, cause the RDGD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RDGD 202 itself, may be located in virtual server(s) running in a cloud-based computing environment rather than being tied to one or more specific physical network computing devices. Also, the application(s) may be running in one or more virtual machines (VMs) executing on the RDGD 202. Additionally, in one or more embodiments of this technology, virtual machine(s) running on the RDGD 202 may be managed or supervised by a hypervisor.

In the network environment 200 of FIG. 2, the RDGD 202 may be coupled to a plurality of server devices 204(1)-204(n) that hosts a plurality of databases 206(1)-206(n), and also to a plurality of client devices 208(1)-208(n) via communication network(s) 210. A communication interface of the RDGD 202, such as the network interface 114 of the computer system 102 of FIG. 1, operatively couples and communicates between the RDGD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RDGD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The RDGD 202 may be a standalone device or integrated with one or more other devices or apparatuses, such as one or more of the server devices 204(1)-204(n). In some embodiments, the RDGD 202 may be hosted by one of the server devices 204(1)-204(n), and other arrangements may also be possible. Moreover, one or more of the devices of the RDGD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the RDGD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the RDGD 202 that may efficiently provide a platform for implementing a platform, language, database, and cloud agnostic recourse data generating module configured to implement artificial intelligence and machine learning models and techniques to generate actionable changes that customers with declined applications may undertake to enhance the likelihood of their new application being approved after implementing the recommended changes, but the disclosure is not limited thereto.

The client devices 208(1)-208(n) may run interface applications, such as standard web browsers or standalone client applications, which may provide an interface to communicate with the RDGD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the RDGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the RDGD 202, the server devices 204(1)-204(n), or the client devices 208(1)-208(n), in some embodiments, may be configured to operate as virtual instances on the same physical machine. In some embodiments, one or more of the RDGD 202, the server devices 204(1)-204(n), or the client devices 208(1)-208(n) may operate on the same physical device rather than as separate devices communicating through communication network(s) 210. Additionally, there may be more or fewer RDGDs 202, server devices 204(1)-204(n), or client devices 208(1)-208(n) than illustrated in FIG. 2. In some embodiments, the RDGD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

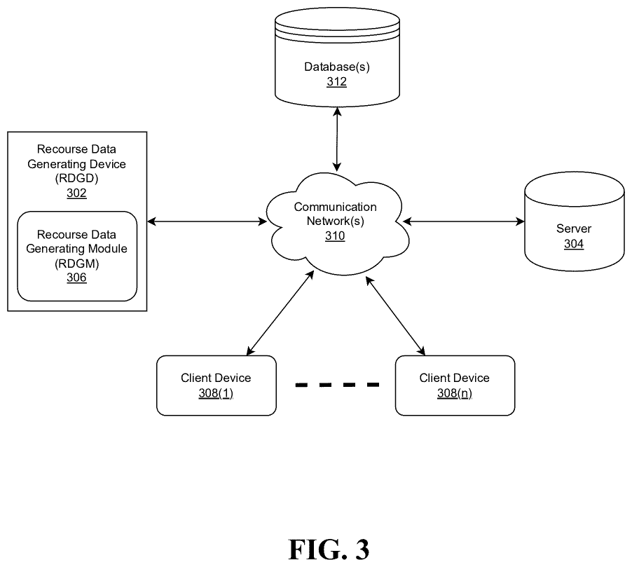

FIG. 3 illustrates a system diagram for implementing a platform, language, and cloud agnostic RDGD having a platform, language, database, and cloud agnostic recourse data generating module (RDGM) in accordance with an embodiment.

As illustrated in FIG. 3, the system 300 may include an RDGD 302 within which an RDGM 306 may be embedded, a server 304, a database(s) 312, a plurality of client devices 308(1) . . . 308(n), and a communication network 310.

In some embodiments, the RDGD 302 including the RDGM 306 may be connected to the server 304, and the database(s) 312 via the communication network 310. The RDGD 302 may also be connected to the plurality of client devices 308(1) . . . 308(n) via the communication network 310, but the disclosure is not limited thereto.

According to exemplary embodiment, the RDGD 302 is described and shown in FIG. 3 as including the RDGM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the RDGM 306 may be configured to receive real-time feed of data from the plurality of client devices 308(1) . . . 308(n) and secondary sources via the communication network 310.

As may be described below, the RDGM 306 may be configured to: receive a first set of training data and a second set of training data that are usable for training a machine learning model, each training data including a plurality of feature values associated with a positive decision or a negative decision on applications received from individuals seeking a pre-desired service from an institution; train the machine learning model by using the first set of training data and the second set of training data to output risk classification data associated with the negative decision; identify, based on the risk classification data, a negatively classified individual who received the negative decision; identify, for the negatively classified individual, individuals whose applications were previously rejected but approved after a certain period of time based on accessing historical data from a database; group, for the negatively classified individual, the individuals whose applications were previously rejected but approved after the certain period of time into a high density cluster by applying a clustering algorithm; and generate, by applying a computing algorithm, a recourse data for the negatively classified individual utilizing similar individuals within the high density cluster whose applications were previously rejected but approved after the certain period of time, and whose features values at a time of rejection are similar to features values of the negatively classified individual, thereby increasing performance of the machine learning model and allowing the negatively classified individual to change the negative decision to the positive decision by implementing the recourse data, wherein the features values may represent one or more of the following data: credit score data, account balance data, data representing how may accounts, mortgage loan data, income data, and car loan data, but the disclosure is not limited thereto. For example, the features values may represent other data as disclosed above.

The plurality of client devices 308(1) . . . 308(n) are illustrated as being in communication with the RDGD 302. In this regard, the plurality of client devices 308(1) . . . 308(n) may be “clients” (e.g., customers) of the RDGD 302 and are described herein as such. Nevertheless, it is to be known and understood that the plurality of client devices 308(1) . . . 308(n) need not necessarily be “clients” of the RDGD 302, or any entity described in association therewith herein. Any additional or alternative relationship may exist between either or both of the plurality of client devices 308(1) . . . 308(n) and the RDGD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the RDGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The RDGD 302 may be the same or similar to the RDGD 202 as described with respect to FIG. 2, including any features or combination of features described with respect thereto.

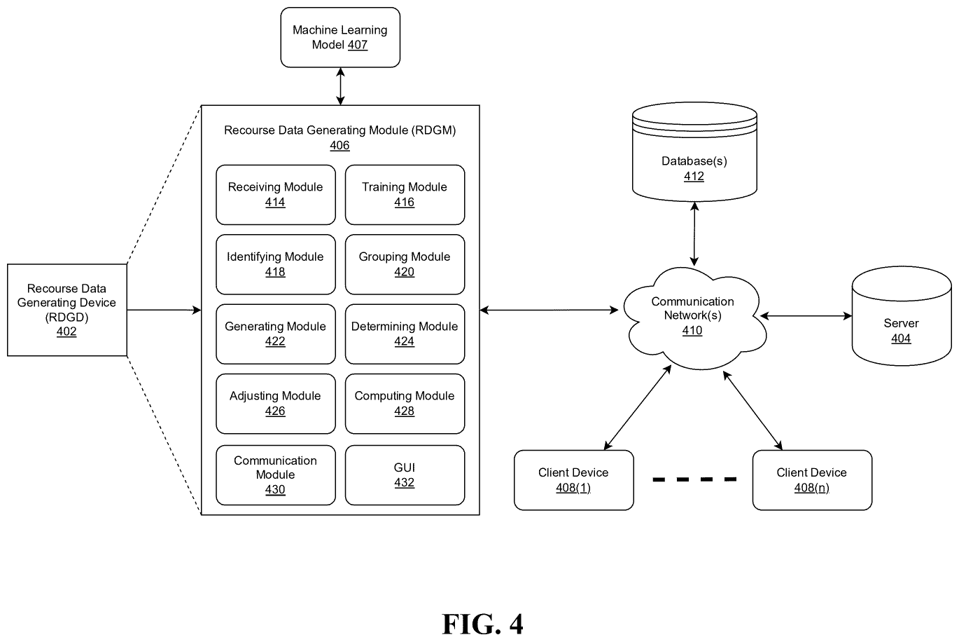

FIG. 4 illustrates a system diagram for implementing a platform, language, database, and cloud agnostic RDGM of FIG. 3 in accordance with an exemplary embodiment.

In some embodiments, the system 400 may include a platform, language, database, and cloud agnostic RDGD 402 within which a platform, language, database, and cloud agnostic RDGM 406 may be embedded, a server 404, a machine learning model 407, database(s) 412, and a communication network 410. In some embodiments, server 404 may comprise a plurality of servers located centrally or located in different locations, but the disclosure is not limited thereto.

In some embodiments, the RDGD 402 including the RDGM 406 may be connected to the server 404, the machine learning model 407, and the database(s) 412 via the communication network 410. The RDGD 402 may also be connected to the plurality of client devices 408(1)-408(n) via the communication network 410, but the disclosure is not limited thereto. The RDGM 406, the server 404, the plurality of client devices 408(1)-408(n), the database(s) 412, the communication network 410 as illustrated in FIG. 4 may be the same or similar to the RDGM 306, the server 304, the plurality of client devices 308(1)-308(n), the database(s) 312, the communication network 310, respectively, as illustrated in FIG. 3.

In some embodiments, as illustrated in FIG. 4, the RDGM 406 may include a receiving module 414, a training module 416, an identifying module 418, a grouping module 420, a generating module 422, a determining module 424, an adjusting module 426, a computing module 428, a communication module 430, and a Graphical User Interface (GUI) 432. In some embodiments, interactions and data exchange among these modules included in the RDGM 406 provide the advantageous effects of the disclosed invention. Functionalities of each module of FIG. 4 may be described in detail below with reference to FIGS. 4-8.

In some embodiments, each of the receiving module 414, training module 416, identifying module 418, grouping module 420, generating module 422, determining module 424, adjusting module 426, computing module 428, and the communication module 430 of the RDGM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, training module 416, identifying module 418, grouping module 420, generating module 422, determining module 424, adjusting module 426, computing module 428, and the communication module 430 of the RDGM 406 of FIG. 4 may be implemented by microprocessors or similar, and may be programmed using software (e.g., microcode) to perform various functions discussed herein and may optionally be driven by firmware and/or software.

Alternatively, in some embodiments, each of the receiving module 414, training module 416, identifying module 418, grouping module 420, generating module 422, determining module 424, adjusting module 426, computing module 428, and the communication module 430 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the RDGM 406 of FIG. 4 may also be implemented by cloud-based deployment.

In some embodiments, each of the receiving module 414, training module 416, identifying module 418, grouping module 420, generating module 422, determining module 424, adjusting module 426, computing module 428, and the communication module 430 the RDGM 406 of FIG. 4 may be called via corresponding API, but the disclosure is not limited thereto. For example, in some embodiments, the receiving module 414 may be called via a first API, the training module 416 may be called via a second API, the identifying module 418 may be called via a third API, the grouping module 420 may be called via a fourth API, the generating module 422 may be called via a fifth API, the determining module 424 may be called via a sixth API, the adjusting module 426 may be called via a seventh API, the computing module 428 may be called via an eight API, and the communication module 430 may be called via a ninth API. In some embodiments, calls may also be made using event-based message interfaces in addition to APIs.

In some embodiments, the process implemented by the RDGM 406 may be executed via the communication module 436, and the communication network 410, which may comprise plural networks as described above. In some embodiments, in an exemplary embodiment, the various components of the RDGM 406 may communicate with the server 404, and the database(s) 412 via the communication module 430 and the communication network 410 and the results may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

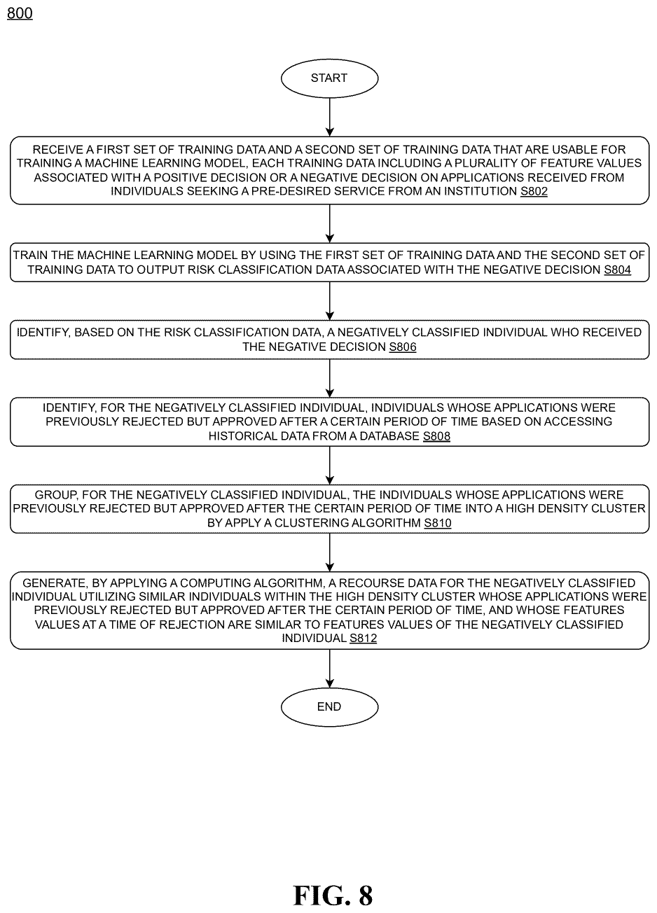

FIG. 8 illustrates a flow chart of a process 800 implemented by the RDGM 406 of FIG. 4 for generating actionable changes with path similarity propagation and counterfactuals in accordance with an embodiment. It may be appreciated that the illustrated process 800 and associated steps may be performed in a different order, with illustrated steps omitted, with additional steps added, or with a combination of reordered, combined, omitted, or additional steps.

Referring to FIGS. 4 and 8, in some embodiments, at step S802, the process 800 may include receiving, by calling the receiving module 414 (see FIG. 4) via a first API, a first set of training data and a second set of training data that are usable for training a machine learning model 407 (see FIG. 4), each training data including a plurality of feature values associated with a positive decision or a negative decision on applications received from individuals seeking a pre-desired service from an institution.

In some embodiments, the features values may represent one or more of the following data: credit score data, account balance data, data representing how may accounts, mortgage loan data, income data, and car loan data, but the disclosure is not limited thereto. For example, although the processes as disclosed herein utilized loan or credit card application, the processes as disclosed herein may be utilized in other use cases, such as where one may change rejected status to an approved status, e.g., managing, matching, and sourcing employment candidates in a recruitment campaign, making decision on carrier improvement, making decision on administering doses of medicine for a treatment plan for a patient, making decision on admitting a patient, admission process to an educational institution where one may change rejected status to an approved status, etc., but the disclosure is not limited thereto.

In some embodiments, the first set of training data may include input raw data: R_train, i.e., X1 (A=0, B=1, C=8, D=9), Y1=1; X2 (A=0, B=30, C=1, D=2), Y2=0; X3 (A=0, B=3, C=8, D=−31), Yn=0; . . . Xn (A=7, B=2, C=6, D=5), Yn=0. In some embodiments, the first set of training data may also include input raw data: R_test, i.e., X1 (A=0, B=1, C=8, D=9); X2 (A=0, B=30, C=1, D=2); X3 (A=0, B=3, C=8, D=−31); . . . Xn (A=7, B=2, C=6, D=5). In some embodiments, “X” may indicate input and A, B, C, D, etc., may correspond to feature values of an applicant, e.g., A=0 may indicate that the applicant has zero (0) mortgage loan; B=1 may indicate that the applicant has one (1) car loan; C=8 may indicate the age of the oldest account is eight (8) years; D=9 may indicate that the applicant has opened nine (9) accounts over the last five years, etc., but the disclosure is not limited thereto. In some embodiments, “Y” may indicate output where “1” may indicate rejection to an application and “0” may indicate approval to an application, but the disclosure is not limited thereto.

In some embodiments, the second set of training data may include accuracy target, i.e., manifested by statistic metrics for measuring quality of prediction (for example, Mean Squared Error). In an embodiment, the accuracy may be a value in interval 0 and 1, i.e., 0.8, but the disclosure is not limited thereto. Training the machine learning model 407 with the first and second set of training data as disclosed herein improves performance of the machine learning model 407 in identifying a list of features as significant and actionable that are likely to improve over the predefined period of time based on the list of features. In some embodiments, in the process 800, the machine learning model 407 may include one or more of the following models: decision tree, ensemble trees, logistic regression, neural network architectures, and predictive model as disclosed above, but the disclosure is not limited thereto.

In some embodiments, feature values associated with a positive decision may include data, corresponding to an individual whose application for a loan or a credit card has been approved, including income data that is more than a preconfigured threshold value, i.e., within a range of $25,000 per year to $55,000 per year; credit score data that is a value more than a preconfigured threshold value, i.e., within a range of 550-650; asset data that is more than a preconfigured threshold value, i.e., within a range of $5000-$10,000, etc., but the disclosure is not limited thereto.

In some embodiments, feature values associated with a negative decision may include data, corresponding to an individual whose application for a loan or a credit card has been rejected, including income data that is less than a preconfigured threshold value, i.e., within a range of $25,000 per year to $55,000 per year; credit score data that is a value less than a preconfigured threshold value, i.e., within a range of 550-650; asset data that is less than a preconfigured threshold value, i.e., within a range of $5000-$10,000, etc., but the disclosure is not limited thereto.

In some embodiments, the pre-desired service may refer to applications for a car loan, home loan, home equity line of credit, a credit card, etc. from an institution, e.g., a bank, but the disclosure is not limited thereto. For example, as mentioned earlier, although the process 800 as disclosed herein utilized loan or credit card application, the process 800 may also be utilized in other use cases, such as where one may change rejected status to an approved status, e.g., managing, matching, and sourcing employment candidates in a recruitment campaign, making a decision on carrier improvement, making a decision on administering doses of medicine for a treatment plan for a patient, making a decision on admitting a patient, admission process to an educational institution where one may change rejected status to an approved status, etc., but the disclosure is not limited thereto.

At step S804, the process 800 may include training, by calling the training module 416 via the second API, the machine learning model 407 by using the first set of training data and the second set of training data to output risk classification data associated with the negative decision. In some embodiments, the training module 416 may be configured to train the machine learning model 407 by using the first set of training data and the second set of training data to output model M_R to be utilized for risk classification data associated with the negative decision. As mentioned earlier, in some embodiments, other models may be computed: neural network, logistic regression, etc., but the disclosure is not limited thereto. For example, the machine learning model 407 may include one or more of the following models: decision tree, ensemble trees, logistic regression, neural network architectures, and predictive model, but the disclosure is not limited thereto.

In risk classification, decision threshold on risk data may utilized as input to output a binary decision Yi for every input individual Xi.

In some embodiments, input time series (TS) data (i.e., historical observations of the same features as in R, for different individuals, over K consecutive months) may be input to a pre-processing step to identify individuals who successfully improved their performance over K months. For example, the TS data for Month 1 may include: X1 (A=0, B=3, C=4, D=9); X2 (A=2, B=20, C=4, D=2); X3 (A=4, B=4, C=8, D=−30); . . . Xn (A=2, B=7, C=6, D=11); the TS data for Month 2 may include: X1 (A=0, B=30, C=5, D=10); X2 (A=2, B=20, C=5, D=2); X3 (A=3, B=40, C=8, D=−31); . . . Xn (A=1, B=17, C=7, D=10); . . . the TS data for Month K may include: X1 (A=7, B=90, C=15, D=0); X2 (A=4, B=20, C=9, D=2); X3 (A=12, B=120, C=8, D=−51); . . . Xn (A=0, B=77, C=11, D=10). The TS data may be stored onto the database 412 (see FIG. 4) for access by the RDGM 406 to be utilizing the process 800 disclosed herein.

In some embodiments, the decision threshold on risk data may also be input to the pre-processing step to identify individuals who successfully improved their performance (i.e., received approval after initial denial) over K months and samples the TS data. The database 412 may be configured to store these approved individuals' both declined and approval months' data, i.e., historical data HIST(X). For example, a set of tuples HIST(X) may include both initial denied/declined application and future approved application of the same applicant (i.e., customer). That is, HIST(X) may be represented as a collection of pairs, where each pair for a customer may consist of two elements: one representing the features of a declined customer's application, and the other representing its features at the first approved state. For example, HIST(X)={(d1,a1), (d2,a2), . . . ,}, where d1 =(A=0, B=3, C=4, D=9) and a1 =(A=1, B=3, C=4, D=9). In some embodiments, HIST(X) for denied data [HIST DENIED] for a customer may include for a customer as follows: Xi (A=0, B=1, C=8, D=9); Xj (A=0, B=30, C=1, D=2); Xk (A=0, B=3, C=8, D=−31); . . . Xm (A=3, B=1, C=5, D=−21). In some embodiments, HIST(X) for approved data [HIST APPROVED] for the same customer whose application was later approved after initial denial after a preconfigured time (i.e., K months) may include: Xi (A=0, B=2, C=7, D=9), Yi=0; Xj (A=1, B=32, C=0, D=2), Yj=0; Xk (A=0, B=4, C=8, D=−35), Yk=0; . . . Xm (A=2, B=6, C=5, D=−21), Ym=0.

In some embodiments, “X” represents all customers in HIST(X) and “X” represents a specific customer in P(X) and HDC(X) discussed below.

At step S806, the process 800 may identify, by calling the identifying module (see FIG. 4) 418 via the third API, based on the risk classification data as mentioned above, a negatively classified individual (may be represented as R_denied) who received the negative decision (i.e., received a denial of his/her application) and output raw data only for the denied applicants R_denied. Examples of raw data for the denied applicants R_denied may include: X1 (A=0, B=1, C=8, D=9), Y1=1; X6 (A=0, B=80, C=1, D=2), Y6=1; X22 (A=0, B=3, C=8, D=−51), Y22=1; . . . Xk (A=7, B=2, C=6, D=5), Yk=1. The HIST(X) data as mentioned above may be input to a process for identifying, for each currently denied individual from R_denied, all Epsilon-nearest applications among [HIST DENIED].

At step S808, the process 800 may identify, by calling the identifying module (see FIG. 4) 418 via the third API, for the negatively classified individual, individuals whose applications were previously rejected but approved after a certain period of time (i.e., K months as mentioned earlier) based on accessing the historical data HIST(X) from the database 412 (see FIG. 4).

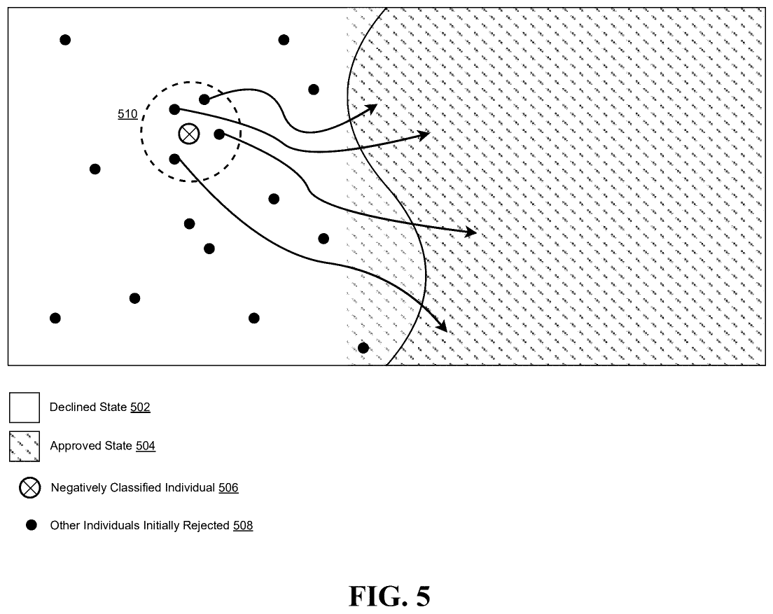

FIG. 5 illustrates a graphical representation 500 of a declined state 502 and an approved state 504 of applicants (i.e., negatively classified individual 506) and identification of applicants (i.e., other individuals initially rejected 508) who are neighbors (i.e., the other individuals within the circle 510 who were successful in changing their status from a declined state 502 to an approved state 504) to a currently declined applicant (i.e., negatively classified individual 506; also represented above as R-denied), in accordance with an embodiment. For example, if neighbors who became successful in the future is represented as P(X), the process 800 at step S808 may identify these neighbors P(X) by standardizing all data coordinate-wise and using (weighted) Euclidian distance, but the disclosure is not limited thereto. That is, this above-described algorithm may include, for every point x in R_denied, find M>0 nearest customers in HIST(X) based on their declined applications. Let ε (Epsilon)>0, then for every point x in R_denied denote by P(X) the subset of M nearest points that lies in ε-neighborhood of x. Adjust ε such that for more than a configurable predetermined threshold of points, i.e., 95% of points in R_denied, their P(X) has at least one point. In some embodiments, P(X) set may be relatively large for majority of points x in R(x). This condition may be easy to satisfy when HIST(X) is large. The parameter M and ε are tuned additionally later based on the performance of the algorithm. For example, the process 800, at step 808, may include adjusting, by calling the adjusting module 426 via the seventh API, the ε until over 95% of points in R_denied have a close successful neighbor (i.e., have non-empty P(X)).

In some embodiments, the process 800, at step S808, may output denied point R_denied Xi, and corresponding successful neighbors set P(X) of similar points in HIST(X), with time initial (denied) and final (approved) feature values for each successful neighbor, i.e., for R_denied X1, the similar approved people are HIST X1, HIST X43, HIST X55, HIST X120; for R_denied X6, the similar approved people are HIST X8, HIST X15, HIST X20, HIST X93, HIST X100; for R_denied X22, the similar approved people are HIST X11, HIST X25, HIST X50, HIST X48 . . . , etc., but the disclosure is not limited thereto. For example, R_denied X1 (A=0, B=1, C=8, D=9), Y1=1, may be most similar to P(X1) HIST DENIED as follows: X1 (A=. . . , B=. . . , C=. . . , D=. . . ), Y1=1; X43 (A=. . . , B=. . . , C=. . . , D=. . . ), Y43=1; X55 (A=. . . , B=. . . , C=. . . , D=. . . ), Y55=1; X120 (A=. . . , B=. . . , C=. . . , D=. . . ), Y120=1. And R_denied X1 (A=0, B=1, C=8, D=9), Y1=1, may be most similar to P(X1) HIST APPROVED as follows: X1 (A=. . . , B=. . . , C=. . . , D=. . . ), Y1=0; X43 (A=. . . , B=. . . , C=. . . , D=. . . ), Y43=0; X55 (A=. . . , B=. . . , C=. . . , D=. . . ), Y55=0; X120 (A=. . . , B=. . . , C=. . . , D=. . . ), Y120=0.

Similarly, R_denied X6 (A=0, B=80, C=1, D=2), Y1=1, may be most similar to P(X6) HIST DENIED as follows: X8 (A=. . . , B=. . . , C=. . . , D=. . . ), Y8=1; X15 (A=. . . , B=. . . , C=. . . , D=. . . ), Y15=1; X20 (A=. . . , B=. . . , C=. . . , D=. . . ), Y20=1; X93 (A=. . . , B=. . . , C=. . . , D=. . . ), Y93=1; X100 (A=. . . , B=. . . , C=. . . , D=. . . ), Y100=1. And R_denied X6 (A=0, B=80, C=1, D=2), Y1=1, may be most similar to P(X6) HIST APPROVED as follows: X8 (A=. . . , B=. . . , C=. . . , D=. . . ), Y8=0; X15 (A=. . . , B=, C=. . . , D=. . . ), Y15=0; X20 (A=. . . , B=. . . , C=. . . , D=. . . ), Y20=0; X93 (A=. . . , B=. . . , C=. . . , D=. . . ), Y93=0; X100 (A=. . . , B=. . . , C=. . . , D=. . . .), Y100=0, and so on until R_denied Xk is generated.

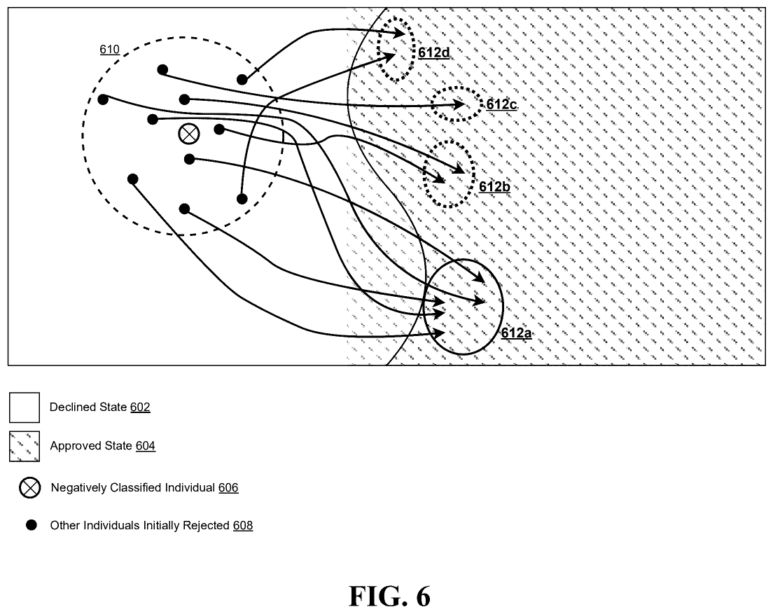

FIG. 6 illustrates a graphical representation 600 of clusters 612a, 612b, 612c, 612d of applicants, among the other individuals initially being rejected 608, who successfully changed their status from a declined state 602 to an approved state 604 in accordance with an embodiment. The individuals 608 within the circle 610 were successful in changing their status from a declined state 602 to an approved state 604.

Referring back to FIGS. 4, 6, and 8, in some embodiments, at step S810, the process 800 may group by calling the grouping module 420 (see FIG. 4) via the fourth API, for the negatively classified individual 606 (see FIG. 6), the individuals (see FIG. 6) whose applications were previously rejected but approved after the certain period of time into a high density cluster 612a by applying a clustering algorithm.

In some embodiments, in applying the clustering algorithm, at step S810, the process 800 may further include: determining, by calling the determining module 424 (see FIG. 4) via the sixth API, a parameter “epsilon (249 )” as mentioned above which is a radius of a circle (see, e.g., 610 in FIG. 6) that is drawn around a data point representing the negatively classified individual 606 to determine how many other data points representing the individuals whose applications were previously rejected but approved after the certain period of time are within the circle 610; and adjusting, by calling the adjusting module 426 (see FIG. 4) via the seventh API, the epsilon until a preconfigured number of data points representing the individuals whose applications were previously rejected but approved after the certain period of time (i.e., K months as mentioned above) have a nearby approved individual. In some embodiments, the positive decision may represent an approved state 604 on applications received from the individuals seeking the pre-desired service from the institution as discussed above and the negative decision may represent a declined state 602 on applications received from the individuals seeking the pre-desired service from the institution as discussed above.

The clustering algorithm is disclosed below with reference to FIGS. 4-6 and 8.

For a given denied customer/applicant/individual X (see, e.g., negatively classified individual 606 in FIG. 6), the grouping module 420 (see FIG. 4) may be configured to group P(X) into high density clusters HDC(X) (see, e.g., 612a, 612b, 612c, 612d in FIG. 6). If P(X) is an empty set, then the step S810 of the process 800 may output no solution to the optimization and generate a general statement for customer recommended recourse. Input data for grouping may include tiers for the size P(X): M1<M2<M3<M4; and example values may include: <10 —use nearest point, [10, 30]—2 means clustering, [30, 60]—3 means clustering, [60, 90]—4 means clustering, >90—5 means clustering (90% data), but the disclosure is not limited thereto.

If the size of neighbor set M is “0”, the RDGM 406 may output a generic recourse advice onto the GUI 432 for the denied individual X (see FIG. 4), i.e., try to keep your utilization low; avoid missing payments, etc., but the disclosure is not limited thereto.

If the size of neighbor set is 0<|P(X)|<M1, then the step S810 of the process 800 may select the closest “denied” point to X in P(X) based on the declined instance. If the size of neighbor set is M1<=|P(X)|>M2, then the grouping module 420 may group the “approved” points in P(X) using the 2-means clustering mentioned above. If the size of neighbor set is M2<=|P(X)|<M3, then the grouping module 420 may group the “approved” points in P(X) using the 3-means clustering mentioned above. If the size of neighbor is set M3<=|P(X)|<=M4 then the grouping module 420 may group, the “approved” points in P(X) using the 4-means clustering mentioned above. If the size of neighbor set is M4<|P(X)|, then the grouping module 420 may group the “approved” points in P(X) using the 5-means clustering mentioned above. The step S810 of the process 800 may then output either a customer or a high density customer cluster—cluster with the most points that may be denoted as HDC(X), i.e., a selected point (approved and denied states) or a selected cluster of points (approved and denied states), as mentioned above (see FIG. 6). The 2-means clustering, 3-means clustering, 4-means clustering and the 5-means clustering all select the cluster with the most “approved” points (see, e.g., 612a in FIG. 6).

For example, R_denied X1 (A=0, B=1, C=8, D=9), Y1=1, may be most similar to HDC(X) HIST DENIED as follows: X1 (A=. . . , B=. . . , C=. . . , D=. . . ), Y1=1; X55 (A=. . . , B=. . . , C=. . . , D=. . . ), Y55=1. And R_denied X1 (A=0, B=1, C=8, D=9), Y1=1, may be most similar to HDC(X) HIST APPROVED as follows: X1 (A=. . . , B=. . . , C=. . . , D=. . . ), Y1=0; X55 (A=. . . , B=. . . , C=. . . , D=. . . ), Y55=0, but the disclosure is not limited thereto.

Referring back to FIGS. 4, 6, and 8, at step S812, the process 800 may generate, by calling the generating module 422 (see FIG. 4) via the fifth API, by applying a computing algorithm, a recourse data for the negatively classified individual 606 (see FIG. 6) utilizing similar individuals within the high density cluster HDC(X) (see 612a in FIG. 6) whose applications were previously rejected but approved after the certain period of time (i.e., K months as discussed above), and whose features values at a time of rejection are similar to features values of the negatively classified individual 606.

In some embodiments, in generating the recourse data by applying the computing algorithm, at step S812, the process may further include: determining, by calling the determining module 424 via the sixth API, a data point representing the nearby approved individual (see e.g., the individuals among the other individuals rejected 608 within the circle 610 in FIG. 6) whose application was previously rejected but approved after the certain period of time to the data point representing the negatively classified individual 606 within the HDC(X) 612a considering the declined state; computing, by calling the computing module 428 (see FIG. 4) a difference in distance between the data point representing the negatively classified individual 606 and a data point of the nearby approved individual within the HDC(X) 612a; and generating, by calling the generating module 422 (see FIG. 4) the recourse data for the negatively classified individual 606 based on the computed difference.

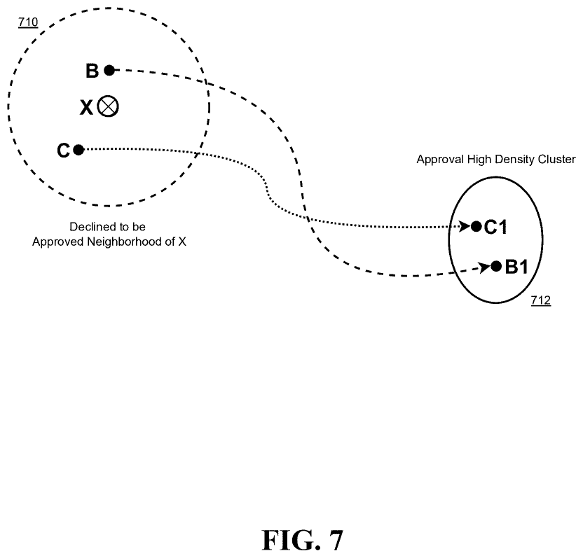

In some embodiments, the computing algorithm is described below with reference to FIGS. 4, 7, and 8. FIG. 7 illustrates a process 700 implemented by the RDGM 406 of FIG. 4 for computing actionable changes (recourse data) utilizing successful applications of similar applicants/individuals in accordance with an embodiment. As illustrated in FIG. 7, within the circle 710, elements B and C represent neighbors, whose application was previously declined but to be approved after certain time (e.g., K months as discussed above), to currently declined applicant X. Element 712, i.e., HDC(X) as mentioned earlier, represent approval high density cluster which includes approved application of B as B1 and approved application of C as C1.

In some embodiments, for HDC(X), at step S812, the process 800 may implement either algorithm 1 or algorithm 2, for computing the actionable changes (recourse data), for each denied customer (i.e., negatively classified individual 606 as illustrated in FIG. 6) by utilizing successful applications of similar individuals (i.e., B1 and C1 as illustrated in FIG. 7).

Algorithm 1: take the closest customer to X in HDC(X) by considering decline instances, B. Then the required change for customer X is the difference between the closest instance feature values at the time of approval, B1 and the current application feature values. For example, the required change may be represented as: Change=(B−X)+(B1−B)=B1−X. For example, R_denied X1 (A=0, B=1, C=8, D=9), Y1=1, may be most similar to this individual from HDC(X) at denial time HDC(X) DENIED as follows: X55 (A=. . . , B=. . . , C=. . . , D=. . . ), Y55=1. And R_denied X1 (A=0, B=1, C=8, D=9), Y1=1, may be most similar to this individual from HDC(X) at denial time HIST APPROVED as follows: X55 (A=13, B=−1, C=8, D=14), Y55=0 (approved application has these feature values), but the disclosure is not limited thereto.

Algorithm 2 (take the closest customer/applicant/individual to customer X in HDC(X) by considering “approved” states): find the distances from X to all approved instances in HDC(X) and select the change that correspond to the smallest distance. For example, the change may be represented as: Change=(C−X)+(C1−C)=C1−X, due to dist(X, C1)<dist (X, B1). For example, R_denied X1 (A=0, B=1, C=8, D=9), Y1=1, may be most similar to this individual from HDC(X) at denial time HDC(X) DENIED as follows: X55 (A=. . . , B=. . . , C=. . . , D=. . . ), Y55=1. And R_denied X1 (A=0, B=1, C=8, D=9), Y1=1, may be most similar to this individual from HDC(X) at denial time HIST APPROVED as follows: X55 (A=13, B=−1, C=8, D=14), Y55=0 (approved application has these feature values), but the disclosure is not limited thereto.

At step S812, the process 800 may then compute the difference between the original denied customer (e.g., negatively classified individual 606 in FIG. 6) application and the selected approved application (e.g., B1 or C1 in FIG. 7), and then may output values of required changes for customer X, i.e., the difference between the selected approved application feature values at the time of “approval” and the currently denied original customer's (e.g., negatively classified individual 606 in FIG. 6) feature values. For example, Change(X)=(A=13, B=−2, C=1, D=5).

At step S812, the process 800 may then select the changes to report to the customer via the GUI 432 (see FIG. 4). For example, the process 800 at step S812 may select only features that are actionable (based on pre-computed labels), important (based on SHAP), and for which the recommended change may be associated with overall risk score improvement. For example, the Change(X)=(A=13, B=−2, C=1, D=5) may be subjected to filter out features which are not suitable for giving advice on, e.g., filter out features which: are not significant drivers of rejection for this customer; are not contributing to approval; are not actionable; are such that recommended change might likely to risk score reduction, etc., but the disclosure is not limited thereto.

In some embodiments, in computing the actionability labels for each feature, the RDGM 406 may be further configured to: implement, for each feature, an algorithm that utilizes a biggest magnitude change over the predefined period time for each variable (e.g., A, B, C . . . ) and for every individual (e.g., applicant X1, X2, X3, . . . ) by: finding indices of a biggest change interval (e.g., months 5 and 11); classifying each change as “small,” “positive,” or “negative” based on a predefined cutoff for which change to be considered negligibly small. Then tallying the number of small, positive, and negative changes for this feature across all individuals.

In some embodiments, the RDGM 406 may be further configured to classify the feature as “unlikely to improve” when either small changes dominate across all time lags within the change interval or when negative changes dominate over positive changes. For this classifying step, input may be a parameter T defining the “strictness” of the rule for labeling a feature as “unlikely to change”: a feature is “unchanging” if (number of small changes) is T or more percent of total. This method may be based on regression coefficient, but the disclosure is not limited thereto. For example, for every applicant under each variable, the regression coefficient algorithm may be as follows: fit a regression of this variable's values on time, e.g., C˜time; label the coefficient small if it is below a predefined threshold; otherwise label it as “improving” or “getting worse” using know trends of each variable write the outcome Y; and summarize the “small”, “improving,” and “getting worse” labels into a final actionability label for this variable.

Details of how actionability labels for each feature are generated by the RDGM 406 are disclosed in U.S. application Ser. No. 18/905,541, filed Oct. 3, 2024 by the same Applicant, titled “SYSTEM AND METHOD FOR GENERATING RECOURSE WITH DATA-DRIVEN ACTIONABILITY CONSTRAINTS,” (hereinafter, “the '541 application) disclosure of which is incorporated herein by reference in its entirety. In some embodiments, an example of the final set of actionability labels for all features may include: A: likely to improve; B: unlikely to improve; C: likely to improve, D: likely to improve, and so on which may be input to the process of identifying important and actionable changes discussed above.

In some embodiments, a feature attribution method may be applied to the machine learning model 407. This feature attribution method may include Tree SHAP algorithm, but the disclosure is not limited thereto. Details of how the Tree SHAP algorithm is applied by the RDGM 406 are disclosed in the '541 application mentioned above, disclosure of which is incorporated herein by reference in its entirety. Thus, the ranked list of features that “explain” the negative classification for this individual (i.e., X100) may include (as output 1) the following: SHAP_D=16.45; SHAP_R=11.12; SHAP_C=3.45; SHAP_E=2.98; and SHAP_B=1.01, and so on. In some embodiments, the ranked list of features that contribute to “positive” classification (approval) may include (as output 2) the following: SHAP_A=26.25; SHAP_F=8.2; SHAP_G=2.25, and so on. Both output 1 and output 2 may be input to the process of identifying important and actionable changes discussed above.

Then values of required changes for customer X (see FIG. 6) for the important and actionable changes (recourse data) may be displayed onto the GUI 432 as actionable_changes=(C=1, D=5), i.e., recourse advice: we recommend increasing C by 1 and increasing D by 5, but the disclosure is not limited thereto.

In some embodiments, the RDGD 402 may include a memory (e.g., a memory 106 as illustrated in FIG. 1) which may be a non-transitory computer readable medium that may be configured to store instructions for implementing a platform, language, database, and cloud agnostic RDGM 406 for implementing artificial intelligence and machine learning models and techniques to identify/generate recourse data with path similarity propagation and counterfactuals for a negatively classified individual as disclosed herein. The RDGD 402 may also include a medium reader (e.g., a medium reader 112 as illustrated in FIG. 1) which may be configured to read any one or more sets of instructions, e.g., software, from any of the memories described herein. The instructions, when executed by a processor embedded within the RDGM 406 or within the RDGD 402, may be used to perform one or more of the processes as described herein. In a particular embodiment, the instructions may reside completely, or at least partially, within the memory 106, the medium reader 112, and/or the processor 104 (see FIG. 1) during execution by the RDGD 402.

In some embodiments, the instructions, when executed, may cause a processor embedded within the RDGM 406 or the RDGD 402 to perform the following: receiving a first set of training data and a second set of training data that are usable for training a machine learning model, each training data including a plurality of feature values associated with a positive decision or a negative decision on applications received from individuals seeking a pre-desired service from an institution; training the machine learning model by using the first set of training data and the second set of training data to output risk classification data associated with the negative decision; identifying, based on the risk classification data, a negatively classified individual who received the negative decision; identifying, for the negatively classified individual, individuals whose applications were previously rejected but approved after a certain period of time based on accessing historical data from a database; grouping, for the negatively classified individual, the individuals whose applications were previously rejected but approved after the certain period of time into a high density cluster by applying a clustering algorithm; and generating, by applying a computing algorithm, a recourse data for the negatively classified individual utilizing similar individuals within the high density cluster whose applications were previously rejected but approved after the certain period of time, and whose features values at a time of rejection are similar to features values of the negatively classified individual, thereby increasing performance of the machine learning model and allowing the negatively classified individual to change the negative decision to the positive decision by implementing the recourse data, wherein the features values may represent one or more of the following data: credit score data, account balance data, data representing how may accounts, mortgage loan data, income data, and car loan data, but the disclosure is not limited thereto. For example, the features values may represent other data as disclosed above. In some embodiments, the processor may be the same or similar to the processor 104 as illustrated in FIG. 1 or the processor embedded within the RDGD 202, RDGD 302, RDGD 402, and RDGM 406 which may be the same or similar to the processor 104.

In some embodiments, the instructions, when executed, may cause the processor 104 to further perform the following: outputting the recourse data to a graphical user interface of a computing device utilized by the negatively classified individual.

In some embodiments, in applying the clustering algorithm, the instructions, when executed, may cause the processor 104 to further perform the following: determining a parameter “epsilon” which is a radius of a circle that is drawn around a data point representing the negatively classified individual to determine how many other data points representing the individuals whose applications were previously rejected but approved after the certain period of time are within the circle; and adjusting the epsilon until a preconfigured number of data points representing the individuals whose applications were previously rejected but approved after the certain period of time have a nearby approved individual.

In some embodiments, the positive decision may represent an approved state on applications received from the individuals seeking the pre-desired service from the institution and the negative decision may represent a declined state on applications received from the individuals seeking the pre-desired service from the institution, and in generating the recourse data by applying the computing algorithm, the instructions, when executed, may cause the processor 104 to further perform the following: determining a data point representing the nearby approved individual whose application was previously rejected but approved after the certain period of time to the data point representing the negatively classified individual within the high density cluster considering the declined state; computing a difference in distance between the data point representing the negatively classified individual and a data point of the nearby approved individual within the high density cluster; and generating the recourse data for the negatively classified individual based on the computed difference.

In some embodiments, the instructions, when executed, may cause the processor 104 to further perform the following: outputting the recourse data to a graphical user interface of a computing device utilized by the negatively classified individual.

In some embodiments as disclosed above in FIGS. 1-8, technical improvements effected by the instant disclosure may include a platform for implementing a platform, language, database, and cloud agnostic recourse data generating module configured to implement artificial intelligence and machine learning models and techniques to generate actionable changes that customers with declined applications may undertake to enhance the likelihood of their new application being approved after implementing the recommended changes, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating recourse data for a negatively classified individual by utilizing one or more processors along with allocated memory, the method comprising:
receiving a first set of training data and a second set of training data that are usable for training a machine learning model, each training data including a plurality of feature values associated with a positive decision or a negative decision on applications received from individuals seeking a pre-desired service from an institution;
training the machine learning model by using the first set of training data and the second set of training data to output risk classification data associated with the negative decision;
identifying, based on the risk classification data, a negatively classified individual who received the negative decision;
identifying, for the negatively classified individual, individuals whose applications were previously rejected but approved after a certain period of time based on accessing historical data from a database;
grouping, for the negatively classified individual, the individuals whose applications were previously rejected but approved after the certain period of time into a high density cluster by applying a clustering algorithm; and
generating, by applying a computing algorithm, a recourse data for the negatively classified individual utilizing similar individuals within the high density cluster whose applications were previously rejected but approved after the certain period of time, and whose features values at a time of rejection are similar to features values of the negatively classified individual thereby increasing performance of the machine learning model and allowing the negatively classified individual to change the negative decision to the positive decision by implementing the recourse data.

2. The method according to claim 1, wherein the features values represent one or more of the following data: credit score data, account balance data, data representing how may accounts, mortgage loan data, income data, and car loan data.

3. The method according to claim 1, wherein in applying the clustering algorithm, the method further comprising:
determining a parameter “epsilon” which is a radius of a circle that is drawn around a data point representing the negatively classified individual to determine how many other data points representing the individuals whose applications were previously rejected but approved after the certain period of time are within the circle; and
adjusting the epsilon until a preconfigured number of data points representing the individuals whose applications were previously rejected but approved after the certain period of time have a nearby approved individual.

4. The method according to claim 3, wherein the positive decision represents an approved state on applications received from the individuals seeking the pre-desired service from the institution and the negative decision represents a declined state on applications received from the individuals seeking the pre-desired service from the institution.

5. The method according to claim 4, wherein in generating the recourse data by applying the computing algorithm, the method further comprising:
determining a data point representing the nearby approved individual whose application was previously rejected but approved after the certain period of time to the data point representing the negatively classified individual within the high density cluster considering the declined state;
computing a difference in distance between the data point representing the negatively classified individual and a data point of the nearby approved individual within the high density cluster; and
generating the recourse data for the negatively classified individual based on the computed difference.

6. The method according to claim 1, further comprising:
outputting the recourse data to a graphical user interface of a computing device utilized by the negatively classified individual.

7. The method according to claim 1, wherein the machine learning model includes one or more of the following models: decision tree, ensemble trees, logistic regression, neural network architectures, and predictive model.

8. A system for generating recourse data for a negatively classified individual, the system comprising:
a processor; and
a memory operatively connected to the processor via a communication interface, the memory storing computer readable instructions, when executed, causes the processor to:
receive a first set of training data and a second set of training data that are usable for training a machine learning model, each training data including a plurality of feature values associated with a positive decision or a negative decision on applications received from individuals seeking a pre-desired service from an institution;
train the machine learning model by using the first set of training data and the second set of training data to output risk classification data associated with the negative decision;
identify, based on the risk classification data, a negatively classified individual who received the negative decision;
identify, for the negatively classified individual, individuals whose applications were previously rejected but approved after a certain period of time based on accessing historical data from a database;
group, for the negatively classified individual, the individuals whose applications were previously rejected but approved after the certain period of time into a high density cluster by applying a clustering algorithm; and
generate, by applying a computing algorithm, a recourse data for the negatively classified individual utilizing similar individuals within the high density cluster whose applications were previously rejected but approved after the certain period of time, and whose features values at a time of rejection are similar to features values of the negatively classified individual thereby increasing performance of the machine learning model and allowing the negatively classified individual to change the negative decision to the positive decision by implementing the recourse data.

9. The system according to claim 8, wherein the features values represent one or more of the following data: credit score data, account balance data, data representing how may accounts, mortgage loan data, income data, and car loan data.

10. The system according to claim 8, wherein in applying the clustering algorithm, the processor is further configured to:
determine a parameter “epsilon” which is a radius of a circle that is drawn around a data point representing the negatively classified individual to determine how many other data points representing the individuals whose applications were previously rejected but approved after the certain period of time are within the circle; and
adjusting the epsilon until a preconfigured number of data points representing the individuals whose applications were previously rejected but approved after the certain period of time have a nearby approved individual.

11. The system according to claim 10, wherein the positive decision represents an approved state on applications received from the individuals seeking the pre-desired service from the institution and the negative decision represents a declined state on applications received from the individuals seeking the pre-desired service from the institution.

12. The system according to claim 11, wherein in generating the recourse data by applying the computing algorithm, the processor is further configured to:
determine a data point representing the nearby approved individual whose application was previously rejected but approved after the certain period of time to the data point representing the negatively classified individual within the high density cluster considering the declined state;
compute a difference in distance between the data point representing the negatively classified individual and a data point of the nearby approved individual within the high density cluster; and
generate the recourse data for the negatively classified individual based on the computed difference.

13. The system according to claim 8, wherein the processor is further configured to:
output the recourse data to a graphical user interface of a computing device utilized by the negatively classified individual.

14. The system according to claim 8, wherein the machine learning model includes one or more of the following models: decision tree, ensemble trees, logistic regression, neural network architectures, and predictive model.

15. A non-transitory computer readable medium configured to store instructions for generating recourse data for a negatively classified individual, the instructions, when executed, cause a processor to perform the following:
receiving a first set of training data and a second set of training data that are usable for training a machine learning model, each training data including a plurality of feature values associated with a positive decision or a negative decision on applications received from individuals seeking a pre-desired service from an institution;
training the machine learning model by using the first set of training data and the second set of training data to output risk classification data associated with the negative decision;
identifying, based on the risk classification data, a negatively classified individual who received the negative decision;
identifying, for the negatively classified individual, individuals whose applications were previously rejected but approved after a certain period of time based on accessing historical data from a database;
grouping, for the negatively classified individual, the individuals whose applications were previously rejected but approved after the certain period of time into a high density cluster by applying a clustering algorithm; and
generating, by applying a computing algorithm, a recourse data for the negatively classified individual utilizing similar individuals within the high density cluster whose applications were previously rejected but approved after the certain period of time, and whose features values at a time of rejection are similar to features values of the negatively classified individual thereby increasing performance of the machine learning model and allowing the negatively classified individual to change the negative decision to the positive decision by implementing the recourse data.

16. The non-transitory computer readable medium according to claim 15, wherein the features values represent one or more of the following data: credit score data, account balance data, data representing how may accounts, mortgage loan data, income data, and car loan data.

17. The non-transitory computer readable medium according to claim 15, wherein in applying the clustering algorithm, the instructions, when executed, cause the processor to further perform the following:
determining a parameter “epsilon” which is a radius of a circle that is drawn around a data point representing the negatively classified individual to determine how many other data points representing the individuals whose applications were previously rejected but approved after the certain period of time are within the circle; and
adjusting the epsilon until a preconfigured number of data points representing the individuals whose applications were previously rejected but approved after the certain period of time have a nearby approved individual.

18. The non-transitory computer readable medium according to claim 17, wherein the positive decision represents an approved state on applications received from the individuals seeking the pre-desired service from the institution and the negative decision represents a declined state on applications received from the individuals seeking the pre-desired service from the institution.

19. The non-transitory computer readable medium according to claim 18, wherein in generating the recourse data by applying the computing algorithm, the instructions, when executed, cause the processor to further perform the following:
determining a data point representing the nearby approved individual whose application was previously rejected but approved after the certain period of time to the data point representing the negatively classified individual within the high density cluster considering the declined state;
computing a difference in distance between the data point representing the negatively classified individual and a data point of the nearby approved individual within the high density cluster; and
generating the recourse data for the negatively classified individual based on the computed difference.

20. The non-transitory computer readable medium according to claim 15, wherein the instructions, when executed, cause the processor to further perform the following:
outputting the recourse data to a graphical user interface of a computing device utilized by the negatively classified individual.
